(19) United States
(12) Patent Application Publication
(10) Pub. No.: US 2013/0333162 A1
(43) Pub. Date: Dec. 19, 2013

(54) Light Gage Wire Structural Connector

(71) Applicant: Robert W. Miller, Huntington Beach, CA (US)

(72) Inventor: Robert W. Miller, Huntington Beach, CA (US)

(21) Appl. No.: 13/495,638

(22) Filed: Jun. 13, 2012

(51) Int. Cl. F16G 11/00

(52) U.S. Cl. 24/135 R

(57) ABSTRACT

A wire connector designed to create a structural parallel line-splice in light gage metal wires. The connector is useful to make quick adjustments for hanging wire lengths. The connector also facilitates making structural end-loops for hanging wall-pictures and other decor.

### BACKGROUND OF THE INVENTION

1. Field of the Invention

The present invention relates to a wire connector to facilitate making a structural parallel line-splice in lightweight metal wires. This connector would be useful to make a quick adjustment in hanging-wire lengths. This connector produces end-loops required for hanging wall pictures and other décor.

2. Description of the Prior Art

Making end loops in stranded or braided wire is a common activity for hanging wall décor. In the case of hanging picture frames, typically the hanging wire will attach to eyelets installed in the frame of the picture. The hanging wire is looped through the eyelet, and then twisted for some additional length to insure that the resulting wire loop would not slip (see FIG. 1 herein). The lightest wire gages (#1-#2) can be knotted with some difficulty, but then are still twisted for some length to insure retention. For the do-it-yourself person, tying a knot in the stranded wire can be frustrating due to the stiffness and friction of the wire. Then there is the annoyance of one of the 10 mil wire strands poking a hole in one's finger. Another drawback of typical prior art is that it is difficult to provide a precise wire length while tying wire to an eyelet. A wire connector that could make quick structural end loops in lightweight stranded wire would be useful. A wire connector that allowed for precise determination of hanging-wire length would reduce installation time required for wall decor changes. An assembled picture wire having precise end loops could be attached to the shaft of a regular screw in the frame, instead of requiring an eyelet screw.

### SUMMARY OF THE INVENTION

Accordingly, it is the general purpose of the present invention to provide a wire connector that can produce a high strength parallel splice between light-gage wires. This connector would be useful to facilitate making quick consistent structural end loops in hanging support wires. The slip adjustment capability of the connector allows for quick assembly of support wires to exact lengths. This connector does not require special skills or tools.

The connector of the present invention is typically composed of a short length of a small diameter rod section of a polymeric material that is formed or machined to have a narrow core aperture. The OD and ID of connector would be specific for different wire diameters. A typical OD for wire #3.040″ and #4.050″ wire would be a connector ID of 0.250″ with core aperture of 0.090″. The connector has a taper at both ends, to facilitate guiding the stranded wire into the core. A connector for making end loops has a short taper, adjacent to the narrow core aperture. The opposite end has a core ID with length sufficient to accommodate the length diameter of the specified self-tapping screw. A connector for a parallel line splicing is symmetrical and longer, with sufficient length for self-tapping screws at both ends.

To provide a parallel line splice, the wires to be joined are held at a convenient distance that allows the free ends of two wires to overlap each other about two inches. The wire ends are slid through opposite ends of the connector until the free ends are exposed. The two wires are then drawn taut to the desired length. The free wire ends at the connector are bent 90 degrees to mark and hold the connector in position. Using standard pliers to hold the body of connector, a self-tapping screw is inserted in one end of the connector between the two wires, and is fully tightened to lock the wires in place. Again, holding the connector with pliers, the second screw is inserted in the opposite end of connector between the wires and fully tightened.

A picture frame that has eyelets in place may be strung using a short section and a long section of pre-assembled picture-wires that have a structural elongate section at one end. The wire sections are threaded through the eyelets and then joined with a wire connector to produce a hanging wire of correct length. Using the short and longer wire segments, the wire connector location does not interfere with the wall-hook to which the frame is attached at its mid-point.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a perspective showing typical twisted wire loop end attachment to eyelets of a picture frame;

FIG. 2A is a perspective cross-section illustration of the inventive wire connector for producing an end-loop in a wire;

FIG. 2B is a perspective cross-section illustration of the inventive wire connector for producing a parallel line splice between two wires;

FIG. 3 is a cross-section illustration depicting the parallel line connector used to produce a line splice in two wires;

FIG. 4 is a cross-section illustration depicting the connector use to produce an end-loop in a hanging wire; and

FIG. 5 illustrates a picture frame installation similar to FIG. 1, but using the invention herein to splice the wire to a selected length.

### DETAILED DESCRIPTION OF PREFERRED EMBODIMENTS

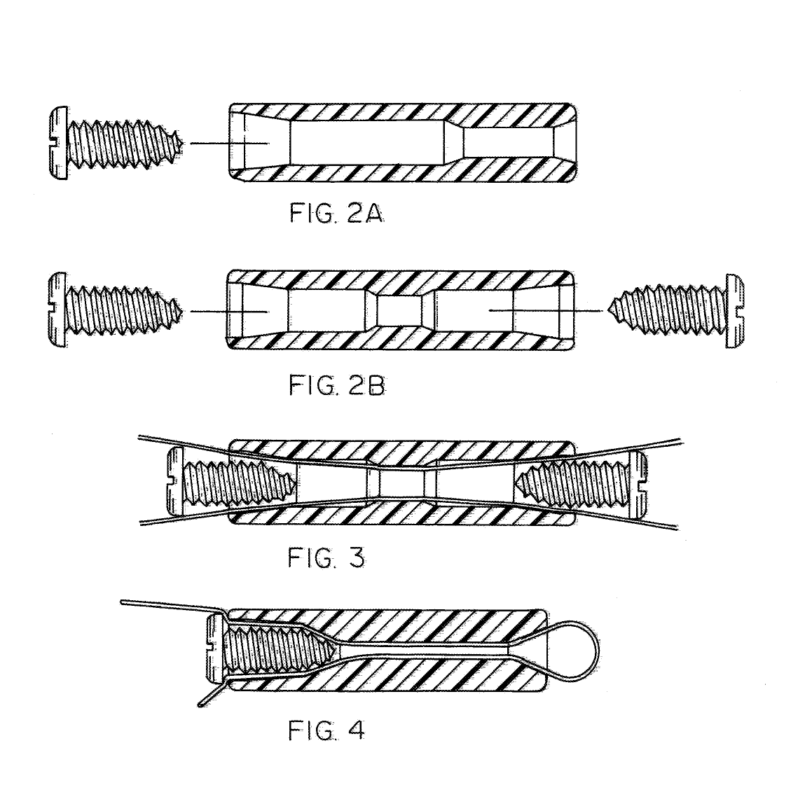

To form end loops (see FIGS. 2A and 4), the first end of the wire to be looped is slid into the wide end opening of the connector. Sufficient wire length is drawn out beyond end of connector to allow for the size of the desired loop and sufficient additional wire to come back through the length of the connector. The inside diameter (ID) of the end-loop is adjustable by placing an appropriate diameter (OD) rod at the loop end, and sliding the connector down to draw the loop taut around the inserted rod. The connector then has the loop formed. At the opposite end of connector, the wires from the loop are separated and spaced to be roughly opposite in the connector aperture. Holding the connector with pliers, the self-tapping screw is inserted between the two wires, and with a screw-driver, fully tightened to thereby mechanically lock the parallel wires in place inside the connector.

To do a parallel line splice (see FIGS. 2B and 3), the wires to be joined are clamped a distance apart allowing the free ends of the two wires to overlap each other about two inches. The connector is slid onto the first wire. The second wire is then fed through the connector in the opposite direction until there is approximately ½ to 1 inch of free wire protruding from each end of the connector. The two wires are then drawn taut, and the free ends of the wires are bent at 90 degrees to mark and hold the connector in that desired location. The self-tapping screws are then installed into the respective ends of the connector using the procedure described above.

If the length of the picture wires is to be exact, the following procedure may be added to the steps for completion of the second end-loop.

One can lay-out on a board the exact wire length desired for the designated picture frame. A stud is installed in the board to mark the location for the center of the second loop. With the first end-loop fixed in place, the wire is drawn taut and bent 90 degrees around the marking stud. This bend marks the center-point for the second end loop. The procedure for the end-loop is then completed as described above.

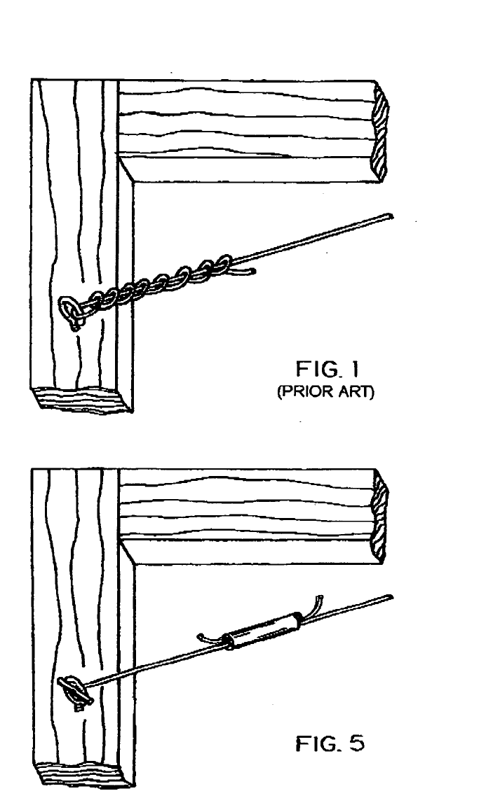

FIGS. 1 and 5 show prior art and inventive eyelet connections respectively, the latter using the connector hereof to splice two lengths of wire.

It will now be understood that the present invention comprises a wire connector that can produce a high strength parallel splice between light-gage wires. The slip adjustment capability of the connector allows for quick assembly of support wires to exact lengths. This connector does not require special skills or tools. To form end loops, the wire is initially threaded into the connector with sufficient length beyond connector to allow for the desired loop and sufficient wire to come back through the length of the connector. The size of the loop can be controlled by placing an appropriate OD rod at the loop end, and sliding the connector down until a loop end is formed taut around the inserted rod. The self-tapping screw is inserted between the two wire strands extending out from wide end of connector, and fully tightened to thereby mechanically lock the parallel wires in place inside the connector.

Various additions and modifications will now occur to those of skill in the relevant art having the benefit of the teaching herein. Accordingly, the scope hereof is not limited to the disclosed embodiments, but only by the appended claims and their legal equivalents.

I claim:

1. A connector for making a quick assembly splice in light gage structural wire to produce adjustable close tolerance wire lengths for decorative hanging applications; the connector comprising:
an elongated hollow tube having a polymeric material having an axial channel therethrough over the full length of the tube from a first end to a second end, said channel being of sufficient diameter at its interior to receive said wires in opposed relation;
each of said first and second ends of said axial channel being tapered
to accommodate insertion of a locking screw that upon insertion will deform the end of the tube to accept the screw thread, and at that same time, deform the wire strands to be locked between the projections of the screw thread and the threaded shape pressed into the surface of the bore by the advancing lockscrew.

2. (canceled)

3. A wire connector as described in claim 1 that can be adjusted to approximate desired length, lightly tightening the lock screws to retain wire positions while length is checked for fit; the lockscrew can then be loosened to allow readjustment of opposing wire lengths to obtain required fit and then be tightly secured with the lockscrews.
